(19) United States
(12) Patent Application Publication
(10) Pub. No.: US 2026/0299130 A1
(43) Pub. Date: Oct. 1, 2026

(54) Body Component for a Motor Vehicle and Motor Vehicle Having Same

(71) Applicant: Bayerische Motoren Werke Aktiengesellschaft, Muenchen (DE)

(72) Inventor: Marcus Knechtel, Kirchheim (DE)

(21) Appl. No.: 19/489,850

(22) PCT Filed: Apr. 12, 2024
(86) PCT No.: PCT/EP2024/059965

§ 371 Date: Dec. 3, 2025

(30) Foreign Application Priority Data
Jun. 22, 2023 (DE) 10 2023 116 426.0

(51) Int. Cl. G01S 17/88; E05F 15/78; G01B 11/02; G01S 13/08; G01S 13/88; G01S 15/08; G01S 15/88; G01S 17/08

(52) U.S. Cl. CPC G01S 17/88; E05F 15/78; G01B 11/026; G01S 13/08; G01S 13/88; G01S 15/08; G01S 15/88; G01S 17/08; E05Y 2400/322; E05Y 2900/531

(57) ABSTRACT

A body component for a motor vehicle is actuated by a vehicle-side actuating device in order to carry out an automated changing of the arrangement of the body component. The body component includes a retroreflector configured to reflect a measurement signal emitted by a measuring device of the motor vehicle. The body component reflects the measurement signal back to the measuring device.

The present application is the U.S. national phase of PCT Application PCT/EP2024/059965 filed on Apr. 12, 2024, which claims priority of German patent application No. 10 2023 116 426.0 filed on Jun. 22, 2023, the entire contents of which are incorporated herein by reference.

### TECHNICAL FIELD

The present disclosure relates to the field of motor vehicles, and more particularly to body components for motor vehicles. w

### BACKGROUND

Body components that can be driven and thus actuated in an automated manner are known from the prior art. Examples of such body components include a door or a flap.

DE 10 2021 122 832 discloses a locking arrangement for a vehicle, comprising two locks for locking a flap of the vehicle, and an opening device, which is connected to the first lock via a first pulling means for unlocking the first lock, and which is connected to the second lock via a second pulling means for unlocking the second lock, wherein the opening device comprises an actuating device, and wherein the opening device comprises an alternating mechanism that is designed to alternately pull the first pulling means and the second pulling means by actuation of the actuating device. Preferably, on the first lock and/or on the second lock there is sensor for sensing a state of the respective lock. In particular, the state of locking or unlocking of the lock is sensed by the sensor. A warning notice can be issued to the vehicle user by means of this sensor. If there is a sensor on both locks, it is ensured that the user has securely locked the flap and/or that a warning tone, or message, appears as soon as it is first operated from inside the vehicle.

In the case of driven body components, in addition to the state in an end position, thus for example in the case of a locked lock, the precise identification and/or ascertainment of an arrangement, position or deflection of the body component, and optionally its velocity, can be important for safety features such as, for example, anti-entrapment protection and for the fulfilment of comfort features for a user of the vehicle, for example a customer.

Existing systems ascertain the position and velocity, for example, on the basis of a number of Hall edges, i.e. a signal from a Hall sensor, that are generated, for example via an opening angle, by a motor driving the body component. The flanks of the Hall sensor signal (‘Hall flanks) can be used, for example, to count the number of revolutions of the motor in order to ascertain the deflection of the body component.

Typically in these cases, a counter is initialized when the body component assumes a defined arrangement, for example in an end position. This is intended to minimize cumulative errors caused by mis-counting when adding up the number of Hall flanks, thus avoiding the output of a signal indicating an incorrect position, for example that a door has become locked.

The velocity and/or acceleration of the body component may also be ascertained from the temporal development of the arrangement of the body component, via temporal derivatives of the signal. A negative acceleration in this case may indicate an entrapment, which can be significant for anti-entrapment protection.

With Hall sensors, however, mis-counting occurs to a certain extent. This results in a possibly incorrect assumption about the position of the body component. If the vehicle electrical system goes to sleep, for example if it is switched off, information about the arrangement of the body component may be lost, as no absolute values relating to the arrangement of the body component can be sensed. A new initialization is necessary, for example by manually closing a door. In general, the assumption of an incorrect position is negative for customer functions, for example a so-called soft run-down before an open stop, and for safety functions, for example anti-entrapment protection and/or approaching positions in front of obstacles.

Against the background of this prior art, there is a need for a device that is suitable for enhancing the prior art and at least overcoming the above-mentioned disadvantages of the prior art. For example, there is a need to enable an arrangement of a motor-vehicle body component that can be actuated in an automated manner to be ascertained more reliably and more accurately in a cost-effective manner.

### SUMMARY

The above-described need, as well as others, are addressed by at least some embodiments described herein.

According to one aspect of the disclosure, a body component for a motor vehicle is provided. The body component in this case can be actuated by a vehicle-side actuating device for the automated changing of an arrangement of the body component, wherein the body component has a retroreflector for reflecting a measurement signal, emitted by a measuring device of the motor vehicle, to the measuring device.

It was recognized here that so-called retroreflectors, or corner reflectors, can reflect the incident measurement signal, largely independently of the direction of incidence of the measurement signal from the measuring device onto the retroreflector and in relation to the orientation of the retroreflector, in the direction from which the measurement signal has come, i.e. in the direction of the measuring device. The measuring device in this case is configured to emit the measurement signal and detect the measurement signal reflected by the retroreflector. The measuring device and the retroreflector can thus be used to achieve a propagation-time measurement, and thus an accurate, absolute measurement of an absolute position of the retroreflector, and thus of the body component, that is resistant to errors caused by mis-counting. Consequently, the body component can also be reliably located when the vehicle electrical system is woken up and/or started up, thereby enabling additional comfort functions and/or safety functions. Because motor vehicles sometimes have measuring devices, for example for monitoring the surroundings, the body component with the retroreflector can contribute cost-effectively to the accurate measurement of the arrangement of the body component if the sensing range of the measuring device includes the retroreflector.

It was also recognized that the retroreflector can be tuned to the measuring device in the laboratory and thus shows a special signal characteristic, enabling reliable detection. This avoids the need to model the body component and its reflection properties using complex, memory-intensive and potentially error-prone software, for example, in order to ascertain the signal characteristic. Moreover, errors caused by a change in geometry, for example in the case of an object in a map compartment of a door, can be avoided.

Optionally, the retroreflector and the body component may be realized as a single piece. This enables a cost-effective and locally well-defined arrangement of the retroreflector relative to other components of the body component. Alternatively or additionally, the retroreflector and the body component may be firmly connected to each other by fastening elements.

Optionally, the retroreflector has an edge having an edge length of 0.5 cm to 2.5 cm. In particular, the retroreflector may have, for example, pyramid-shaped, tetrahedron-shaped and/or polyhedron-shaped portions. Such portions have one or more edges. Due to the edge length of 0.5 cm to 2.5 cm, the retroreflector can have an inconspicuous appearance with a comparatively small size, and a distinctive signal can nevertheless be generated for the measuring device.

Optionally, the retroreflector is configured to reflect radar signals, laser signals and/or ultrasonic signals. Reliable propagation-time measurements, for ascertaining the absolute position of the body component, are thus possible. The measuring device in this case is configured, according to the retroreflector, to emit and detect a radar signal, a laser signal and/or an ultrasonic signal. Depending on the sensor technology installed, retroreflectors, or standardized objects, can be recognized reliably and accurately on the basis of their geometry.

Optionally, the retroreflector is configured to reflect the measurement signal to the measuring device at a distance of from 0 m to 2 m between the retroreflector and the measuring device. The retroreflector is dimensioned and arranged accordingly for this purpose, for example with the edge length described above. This makes it possible to detect, for example, the opening of a body component in the form of a door and/or tailgate.

Optionally, the retroreflector is realized as a trim element. This makes it possible for the retroreflector to positively influence the appearance of the body component and/or of the motor vehicle.

Optionally, the body component is realized as a door, a flap and/or a component thereof. It was recognized in this regard that a door and/or a flap can benefit particularly positively from the retroreflector and that a reliable and accurate ascertainment of position can contribute particularly to the fulfilling of comfort functions and/or safety functions.

According to one aspect of the disclosure, a motor vehicle is provided. The motor vehicle comprises the body component described above, an actuating device for the automated changing of an arrangement of the body component, and a measuring device for emitting a measurement signal and for sensing the measurement signal reflected by the retroreflector. The body component may have one or more of the features described above as optional and/or advantageous.

Optionally, the body component is realized as a door, the motor vehicle has a sill associated with the body component, and the measuring device is arranged in and/or on the sill. It was recognized in this regard that a suitable location for arranging the measuring device is in and/or on the sill. This means that the opening of the door can be reliably monitored. Moreover, there is a suitable location in, on and/or under the sill for arranging the measuring device for additional monitoring of the surroundings of the vehicle.

That which has been described above can be summarized in different words and in relation to a specific embodiment, which is described as not being limiting for the present disclosure, as follows: The disclosure relates to a corner element for identifying and locating driven body components. According to the core idea, it was recognized that driven body components can be supplemented by a sensor system for collision avoidance. Modelling the body components in software can be complex, memory-intensive and error-prone. This is particularly the case if a customer changes the contour of the body component, e.g. by placing objects in the map compartment. Depending on the sensor technology installed, e.g. ultrasound, radar or laser, there are standardized objects known as corners that can be detected reliably and accurately due to their geometry. A corner element fixedly connected to a body component improves detection and enables new functions without complex modelling of the door.

The above-described features and advantages, as well as others, will become more readily apparent to those of ordinary skill in the art by reference to the following detailed description and accompanying drawings.

### BRIEF DESCRIPTION OF THE DRAWING

FIG. 1 shows, in schematic form, a body component and a motor vehicle, each according to one aspect of the disclosure.

### DETAILED DESCRIPTION

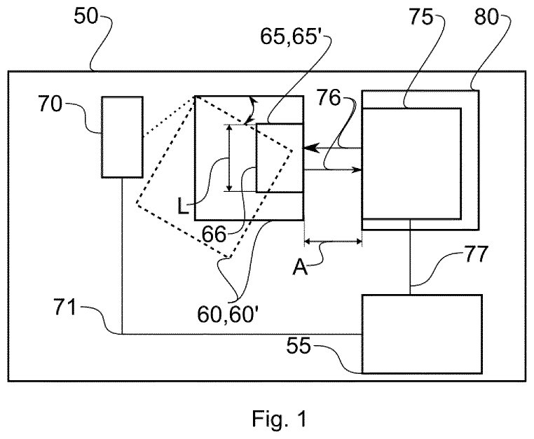

Shown schematically in FIG. 1 is a body component 60 and a motor vehicle 50, each according to one aspect of the disclosure.

The motor vehicle 50 comprises a body component 60, an actuating device 70, a measuring device 75 and a data processing device 55.

The data processing device 55 and the actuating device 70 are connected to each other via communication technology so that the data processing device 55 can send an actuation signal 71 to the actuating device 70.

The actuating device 70 has an electric drive (not shown) that can be activated on the basis of the actuation signal 71 in order to effect automated changing of the arrangement of the body component 60, see the change in the position of the body component 60 indicated schematically in FIG. 1 by a dotted line and a double arrow.

The data processing device 55 and the measuring device 75 are connected to each other by communication technology so that the measuring device 75 can transmit an arrangement signal 77 relating to the arrangement of the body component 60 to the data processing device 55. The arrangement signal 77 may include information relating to the arrangement of the body component 60, relating to a velocity of a movement of the body component 60 and/or relating to an acceleration of the movement of the body component 60.

The data processing device 55 is configured to process the arrangement signal 77 and optionally to output the actuation signal 71 accordingly. In this way, safety functions such as anti-entrapment protection and/or comfort functions such as soft closing can be achieved. On the basis of the arrangement signal 77, for example, the data processing device 55 may recognize a negative acceleration and, in order to avert a possible entrapment, output a corresponding actuation signal 71, for example to open the body component 60 realized as a door 60′. Moreover, obstacles between the measuring device 75 and the body component 60 and/or an end position of the body component 60 may be recognized, in which case a corresponding actuation signal 71 may be output accordingly to change and/or stop the movement of the body component 60.

The measuring device 75 is configured to emit and sense a measurement signal 76. The measuring device 75 is configured to emit and sense a radar signal, a laser signal and/or an ultrasonic signal. The measuring device 75 is configured to ascertain the position of the body component 60 on the basis of the emitted and reflected measurement signal 76 by means of a propagation-time measurement and to output to the data processing device 55 the arrangement information 77 relating to the arrangement and/or movement of the body component 60.

The body component 60 has a retroreflector 65 for reflecting the measurement signal 76, emitted by the measuring device 75 of the motor vehicle 50, to the measuring device 75. The retroreflector 65 is configured to reflect radar signals, laser signals and/or ultrasonic signals. The measuring device 75 is configured to sense the measurement signal 76 reflected by the retroreflector 65.

The retroreflector 65 and the body component 60 are realized as a single piece. For example, the retroreflector 65 and the body component 60 may be manufactured by an injection molding process, optionally with the use of different plastics for the retroreflector 65 and the body component 60. Alternatively, the retroreflector 65 and the body component 60 may be adhesively bonded and/or welded together.

The retroreflector 65 has an edge 66 having an edge length L of 0.5 cm to 2.5 cm. The retroreflector 65 has polyhedron-shaped portions, with the polyhedron-shaped portions having a plurality of edges 66. The edges 66 may be of different edge lengths L. The retroreflector 65 is realized as a trim element 65′.

The retroreflector 65 is configured to reflect the measurement signal 76 to the measuring device 75 at a distance A of from 0 m to 2 m between the retroreflector 65 and the measuring device 75.

The motor vehicle 50 has a sill 80 associated with the body component 60. The measuring device 75 is arranged in and/or on the sill 80. The retroreflector 65 is arranged on an underside of the door 60′, i.e. in the mounted state on a side that faces toward a road and/or a surface.

In another embodiment (not shown), the body component 60 may be realized, for example, as a flap, in particular a tailgate, and the measuring device 75 is arranged in and/or on a stop, or frame.

### REFERENCE DESIGNATIONS (PART OF THE DESCRIPTION)

50 motor vehicle
55 data processing device
60 body component
60′ door
65 retroreflector
65′ trim element
66 edge
70 actuating device
71 actuation signal
75 measuring device
76 measurement signal
77 arrangement signal
80 sill
A distance
L edge length

1.-9. (canceled)

10. A body component for a motor vehicle, the body component configured to be actuated by a vehicle-side actuating device for automated changing of an arrangement of the body component, the body component comprising:
a retroreflector configured to reflect a measurement signal, emitted by a measuring device of the motor vehicle, to the measuring device.

11. The body component as claimed in claim 10, wherein the retroreflector is configured to reflect the measurement signal such that the measurement device can detect the measurement signal and generate a measurement indicative of a position of the body component based at least in part on the reflected measurement signal.

12. The body component as claimed in claim 10, wherein the retroreflector and the body component are realized as a single piece.

13. The body component as claimed in claim 10, wherein the retroreflector has an edge having an edge length of from 0.5 cm to 2.5 cm.

14. The body component as claimed in claim 10, wherein the retroreflector is configured to reflect at least one of the group consisting of: radar signals, laser signals and ultrasonic signals.

15. The body component as claimed in claim 14, wherein the retroreflector is configured to reflect the measurement signal to the measuring device at a distance of from 0 m to 2 m between the retroreflector and the measuring device.

16. The body component as claimed in claim 15, wherein the retroreflector comprises a trim element.

17. The body component as claimed in claim 10, wherein the retroreflector is configured to reflect the measurement signal to the measuring device at a distance of from 0 meters to 2 meters between the retroreflector and the measuring device.

18. The body component as claimed in claim 10, wherein the retroreflector comprises a trim element.

19. The body component as claimed in claim 18, wherein the body component comprises a door or a component thereof.

20. The body component as claimed in claim 18, wherein the body component comprises a flap or a component thereof.

21. The body component as claimed in claim 10, wherein the body component comprises a door or a component thereof.

22. The body component as claimed in claim 10, wherein the body component comprises a flap or a component thereof.

23. A motor vehicle, comprising:
a body component configured to be actuated by a vehicle-side actuating device for an automated changing of an arrangement of the body component, the body component including a retroreflector configured to reflect a measurement signal, emitted by a measuring device of the motor vehicle, to the measuring device;
the measuring device, configured to emit the measurement signal and to sense the measurement signal reflected by the retroreflector.

24. The motor vehicle as claimed in claim 23, wherein the body component comprises a door, the motor vehicle having a sill associated with the body component, and wherein the measuring device is arranged in or on the sill.

25. The motor vehicle as claimed in claim 24, wherein the retroreflector is configured as a trim element.

26. The motor vehicle as claimed in claim 23, wherein the retroreflector is configured as a trim element.

27. The motor vehicle as claimed in claim 23, wherein the measurement device is configured to generate a measurement indicative of a position of the body component based at least on in part on the measurement signal reflected by the retroreflector.
